(19) United States
(12) Patent Application Publication
(10) Pub. No.: US 2013/0170820 A1
(43) Pub. Date: Jul. 4, 2013

(54) VIDEO IMAGE CAPTURE AND PLAYBACK FOR DISPLAY DEVICES

(71) Applicants: Einstein CHENG, Taipei (TW); Louis FENG, Taipei (TW)

(72) Inventors: Einstein CHENG, Taipei (TW); Louis FENG, Taipei (TW)

(73) Assignee: STMicroelectronics Ltd., Tsim Sha Tsui (HK)

(21) Appl. No.: 13/339,622

(22) Filed: Dec. 29, 2011

(51) Int. Cl. H04N 5/92

(52) U.S. Cl. 386/326; 386/E05.001

(57) ABSTRACT

A display controller integrated circuit (IC) is disclosed. The display controller IC includes a video interface that receives an image for real time display on a display. The display controller IC further includes means that is configured to store the image on a data storage device so that it can be displayed again at a later time. A display device including the display controller IC and a method of capturing and displaying images are also disclosed.

### BACKGROUND

This invention relates to a display controller integrated circuit (IC) and a display device. More particularly, this invention relates to a display device including a display controller IC that allows the display device to also function as a digital photo frame.

With the advent of digital cameras, web cams, and cell phones with camera, digital photos and images obtained using such devices are rapidly replacing older, printed photos. These digital photos and images are typically viewed on a display screen of a computing device. Some of these digital photos are, however, still printed and stored in a conventional photo album for viewing. In order to be environmentally friendly, digital photo frames have been developed to display the digital photos instead. Such a digital photo frame generally includes a frame and a liquid crystal display (LCD) screen supported by the frame. The digital photo frame further includes a memory capable of storing numerous digital photos. The stored digital photos can be displayed in a slideshow mode. A user can arbitrarily change the stored digital photos according to his/her liking; something which can't be easily accomplished with a conventional photo frame. In addition to digital photos, images of company signboards, advertisements and welcome messages can also be stored in the digital photo frame, making it an ideal alternative for displaying such information.

There are devices available that can be used both as a computer monitor as well as a digital photo frame. Typically, the device has a Graphic-IN and Video-IN inputs, built-in speakers with amplifier, SD/MS/MMC/CF flash memory card interfaces, a USB interface, built-in image storage memory, etc. The Graphic-IN and Video-IN inputs allow the device to function as a high resolution monitor when connected to a central processing unit (CPU) tower of a personal computer (PC). Through the built-in speakers, the device can playback MP3 audio. The integrated SD/MS/MMC/CF flash memory card interfaces allow images stored on corresponding cards to be read by the device and displayed on its screen. The images can be displayed in an automatic picture slide show mode with zoom in and zoom out features. The slide show mode has multiple transition effects with adjustable display times to provide the optimum effects for the digital photos. The device also supports AVI, JPEG, WMV, MPEG-1, MPEG-2 and MPEG-4 files. The built-in image storage memory can be used to store digital photos and images, music and videos. The USB 2.0 interface provides fast downloads from thumb drives and computers. With such a dual-function device, opportunities to further enhance its feature set abound.

### BRIEF DESCRIPTION OF DRAWINGS

The invention will be better understood with reference to the drawings, in which:

FIG. 1 is block diagram of a personal computer (PC) including a CPU tower and a display device according to one embodiment of the invention;

FIG. 2 is a flowchart showing a sequence of steps in the PC in FIG. 1 for capturing and displaying an image according to another embodiment of the invention;

FIG. 3 is a diagram showing a memory map of a memory of the display device in FIG. 1; and

FIG. 4 is a diagram showing another memory map of the memory in FIG. 3.

### DETAILED DESCRIPTION OF THE EMBODIMENTS

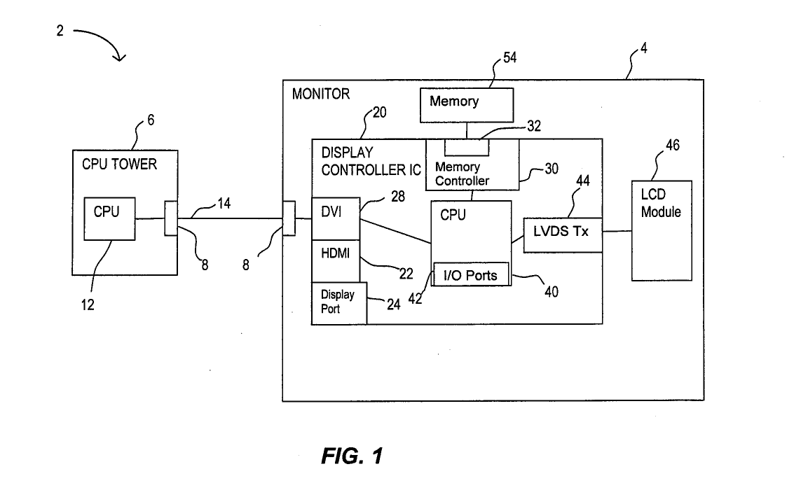

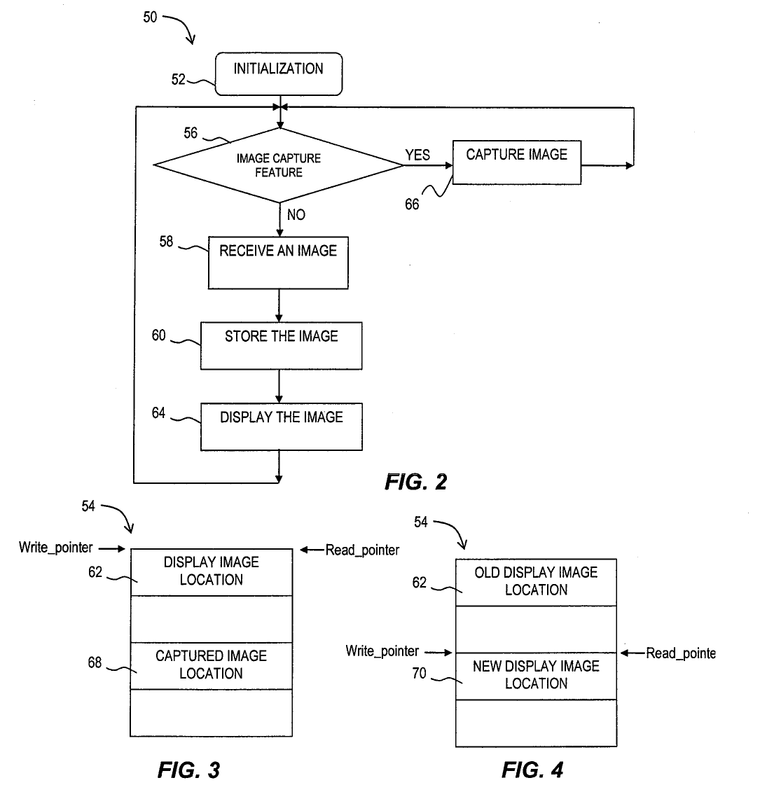

As shown in FIG. 1 for purposes of illustration, the invention may be embodied in a novel display device that includes a display screen, a data storage device, and a video interface. The display device receives one or more images to be displayed on the display screen via the video interface. The display device further includes means for displaying the one or more images as they are received, and means that stores the one or more images in the data storage device so that the one or more images may be displayed at a later time. In this manner, this novel display device is able to capture one or more images that are sent to it for real time display via its video interface for subsequent display.

Specifically, FIG. 1 shows a desktop personal computer (PC) 2 system including a monitor 4, according to an embodiment of the invention, that functions as the display device described above. The desktop PC 2 includes a CPU tower 6 and the monitor 4, each of which has a DVI video interface 8. The CPU tower 6 includes, amongst other components, a central processing unit (CPU) 12. The CPU tower 6 is connected to the monitor 4 via a DVI cable 14. During use, the CPU 12 may run applications like word processing, spreadsheet, databases, presentation, web browsers, e-mail clients, digital media playback, and games and many other personal productivity and special-purpose software applications. The desktop PC 2 also has a connection (not shown) to the Internet, allowing access to the World Wide Web (WWW) and a wide range of other resources available on the WWW. Each of these applications results in images being sent by the CPU 12 to the monitor 4 via the DVI cable 14. The images that are sent to the monitor 4 can be any type of images including, but not limited to, digital photos, advertisements, web pages, spreadsheet tables, documents, video, etc.

The monitor 4 includes a display controller integrated circuit (IC) 20 for controlling the functions of the monitor 4. The display controller IC 20 includes, amongst others, video interfaces including, but not limited to, a HDMI receiver 22, a DisplayPort receiver 24 and a DVI receiver 28. The display controller IC 20 also includes a DDR memory controller 30 including a DDR memory interface 32, an on-chip microprocessor 40 having general purpose inputs/outputs 42 for interfacing with a keypad, a flash memory interface for accessing a memory card, backlight, and a non-volatile random access memory (NVRAM) (all not shown). The display controller IC 20 further includes a DisplayPort transmitter (not shown) and an LVDS transmitter 44 for direct connection to a display that includes, but not limited to, an LCD module 46.

A sequence 50 of steps for displaying images received from the CPU 12 is described next. The sequence 50 starts in an INITIALIZATION step 52, wherein the microprocessor 40 initializes a write_pointer and a read_pointer to point to a display image location 62 in a data storage device, e.g. a DDR memory 54, that is allocated for real time displaying purposes. The sequence 50 next proceeds to an IMAGE CAPTURE FEATURE ACTIVATED? decision step 56, wherein the microprocessor 40 monitors the DVI receiver 28 to determine if an image capture feature has been activated. This image capture feature may be activated by a user through any suitable user interface means. For example, a user may activate the feature by pressing an existing button/key or dedicated button/key on the monitor 4. When it is determined that the image capture feature has not been activated, i.e., the monitor is in a “regular monitor” mode, the sequence 50 proceeds to a RECEIVE AN IMAGE step 58, wherein the microprocessor 40 in the display controller IC 20 controls the DVI receiver 28 to receive an image sent by the CPU 12 for real time display on the monitor 4. The sequence 50 next proceeds to a STORE THE IMAGE step 60, wherein the microprocessor 40 controls the DDR memory controller 30 to store the received image to the display image location 62 in the DDR memory 54 (FIG. 3) pointed to by the write_pointer. If necessary, as is known to those skilled in the art, the received image may be processed before being stored in the display image location 62. Processing of the image may include, but not limited to, image processing, color processing, de-interlacing processing, format processing, etc. Typically, the image is formatted to a raw video data before being stored in the display image location 62. For example, analog signals such as VGA and Component input signals representing the image, are converted to digital format for storing. The sequence 50 next proceeds to a DISPLAY THE IMAGE step 64, wherein the microprocessor 40 retrieves the stored image from the display image location 62 in the DDR memory 54 pointed to by the read_pointer and displays the image on the LCD module 46 in real time. After the image is displayed, the sequence 50 returns to the IMAGE CAPTURE FEATURE ACTIVATED? decision step 56. The sequence 50 will loop around the above described steps to display images received from the CPU 12 by storing each image in the display image location 62 for it to be read and displayed in real time.

If however it is determined in the IMAGE CAPTURE FEATURE ACTIVATED? decision step 56 that a user has activated the image capture feature, the monitor 4 goes into an “image capture” mode wherein the sequence 50 proceeds to a CAPTURE IMAGE step 66. The user may, for example, activate the image capture feature when an image that appeals to the user is displayed on the monitor 4. In this CAPTURE IMAGE step 66, the microprocessor 40 copies the image stored in the display image location 62 to a captured image location 68 in the DDR memory 54 (FIG. 3). This captured image location 68 is different than the display image location 62. The captured image location 68 may be defined in any available memory including a flash memory, any type of memory card or a USB thumb drive connected to the monitor 4. When stored in such memories, the captured image may be reloaded in the DDR memory 54 for display. The captured image may also be edited using an on screen display (OSD) feature to enhance its appearance and/or to add date and other information. The write_pointer and the read_pointer are not updated in this embodiment. In other words, the pointers point to the same display image location 62 when the monitor is in both the “regular monitor” mode and the “image capture” mode.

After the image is captured, the sequence 50 returns to the IMAGE CAPTURE FEATURE ACTIVATED? decision step 56. In this embodiment, only a single image is captured. In other words, each time the capture image feature is activated, the microprocessor 40 copies the latest image in the display memory location 62 to the captured image location 68. The image stored in the captured image location 68 may subsequently be retrieved for display. For example, the captured image may be used as a splash screen for display when the monitor 4 is powered on. Alternatively or additionally, the captured image may be displayed when there is no input signal to the monitor 4, i.e., when the monitor 4 is in a suspended or idle mode.

With this feature, the monitor 4 is able to capture an image that is sent to it via the video interface for real time display to be also displayable at a later time, in addition to those images stored in the built-in image storage and memory cards connected to the monitor 4.

Although the present invention is described as implemented in the above described embodiment, it is not to be construed to be limited as such. For example, it is described that the monitor includes a HDMI receiver, a DisplayPort receiver, and a DVI receiver. It is possible for the monitor to also include any other types of video receivers including, but not limited to, VGA, DVI, DisplayPort, CVBS, S-Video, component, SDI, USB, DiiVA, Thunderbolt and other video receivers/inputs.

As another example, it is described that only one image can be captured at any one time. It should be recognized that more than one image can be captured at any one time. For example, it is possible to have several captured image locations implemented as a circular buffer for storing a corresponding number of captured images. When the buffer is full, previously captured images get overwritten. Each activation of the image capture feature may result in the capture of a single image. Alternatively, each activation may result in capturing more than one image in quick succession. It is also possible to store only images that are different from images in the other captured image locations.

As yet another example, it is described that the image stored in the display image location is copied into the captured image location when the capture image feature is activated. This again should not be construed to be limited as such. Another possible implementation involves changing the value of the write_pointer and read_pointer so that a different location 70 (FIG. 4) in the DDR memory 54 is used as a new display image location, leaving the captured image in the old display image location 62. In other words, the old display image location 62 serves as the captured image location.

As yet a further example, it may not be necessary for the image capture feature to be user activated. The image capture feature may, for example, automatically run when the monitor is powered up to capture a predetermined number of images in a ring buffer. These images can then be displayed when the monitor is in a suspended or idle mode. Alternatively or additionally, a user may activate a feature to display these captured images even though the monitor is still receiving images for real time display.

What is claimed is:

1. A display device comprising:
a display;
a data storage device;
a video interface that receives an image for real time display on the display; and
means that stores the image in the data storage device so that it can be displayed again at a later time.

2. The display device according to claim 1, wherein the video interface comprises a VGA, DVI, HDMI, DisplayPort, CVBS, S-Video, component, SDI, USB, DiiVA, Thunderbolt video interface.

3. The display device according to claim 1, wherein the means that stores the image in the data storage device comprises a user activatable means that stores the image in the data storage device.

4. The display device according to claim 3, wherein the stored image is used as a splash screen.

5. The display device according to claim 1, further comprising means that displays the stored image when the display device is in a suspended or idle mode.

6. The display device according to claim 1, wherein the means that stores the image in the data storage device comprises means that copies the image, stored in a display image location for real time display, to a captured image location in the data storage device.

7. The display device according to claim 6, wherein the means that stores the image in the data storage device comprises means that defines a different display image location of the data storage device for storing an image for real time display so as to leave the image to be stored in an earlier display image location of the data storage device.

8. A display controller integrated circuit comprising:
a video interface that receives an image for real time display on a display; and
means that is configured to store the image on a data storage device so that it can be displayed again at a later time.

9. The display controller integrated circuit according to claim 8, wherein means that is configured to store the image comprises a user activatable means that stores the image in the data storage device.

10. The display controller integrated circuit according to claim 8, further comprising means that displays the stored image when a display device including the display controller integrated circuit is in a suspended or idle mode.

11. The display controller integrated circuit according to claim 8, wherein means that is configured to store the image on a data storage device comprises means that is configured to copy the image, stored in a display image location for real time display, to a captured image location of the data storage device.

12. The display controller integrated circuit according to claim 11, the means that is configured to store the image on a data storage device comprises means that defines a different display image location of the data storage device for storing an image for real time display so as to leave the image to be stored in an earlier display image location of the data storage device.

13. A method comprising:
receiving, over a video interface, an image for real time display on a display; and
storing the image in a data storage device so that it can be displayed again at a later time.

14. The method according to claim 13, wherein storing the image is user-activatable.

15. The method according to claim 13, further comprising retrieving the image from the data storage device and displaying the image when the display is in a suspended or idle mode.

16. The method according to claim 13, further comprising using the stored image as a splash screen.

17. The method according to claim 13, wherein storing the image in the data storage device comprises copying the image, stored in a display image location for real time display, to a captured image location in the data storage device.

18. The method according to claim 17, wherein storing the image in the display comprises defining a different display image location of the data storage device for storing an image for real time display so as to leave the image to be stored in an earlier display image location of the data storage device.

19. The method according to claim 13, further comprising capturing a single image at a time.

20. The method according to claim 13, further comprising capturing more than one image at a time.
